(19) United States
(12) Patent Application Publication
(10) Pub. No.: US 2004/0009287 A1
(43) Pub. Date: Jan. 15, 2004

(54) High energy protein protected ruminant feed and methods for manufacturing and using same

(76) Inventor: Wayne L. Stockland, Omaha, NE (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/611,576

(22) Filed: Jun. 30, 2003

Related U.S. Application Data
(60) Provisional application No. 60/393,324, filed on Jul. 2, 2002.

(51) Int. Cl. A23K 1/16

(52) U.S. Cl. 426/623

(57) ABSTRACT

This invention encompasses high-energy protein-protected ruminant feeds comprising oil seed meal, hulls, water, and fat that have been cooked to give a cooked meal having a temperature of at least 200° F. and a moisture content of from 21 to 26 percent by weight and which are thereafter dried to give high energy protein protected ruminant feeds. The high-energy protein-protected ruminant feeds provide a larger amount of both energy and protein, as well as nourishment, to the lower gut of animals than previously known protein-protected ruminant feeds.

This application claims the benefit of priority from U.S. Provisional Patent Application No. 60/393,324, filed on Jul. 2, 2002, the disclosure of which is explicitly incorporated by reference herein.

### BACKGROUND OF THE INVENTION

1. Field of the Invention

This invention concerns increasing the energy content of protein-protected ruminant feeds. More particularly, the invention relates to methods for manufacturing and using a ruminant feed that, when consumed, provides a larger amount of both energy and protein, as well as nourishment, to the lower gut of animals than previously known protein-protected ruminant feeds. This invention is also a novel high-energy protein-protected ruminant feed.

2. Description of the Art

Ruminants require high levels of energy and protein for maximum growth and performance. Protein-providing feed materials when subjected to digestion in the rumen are thereby downgraded with respect to the feeding value of the protein. It has been proposed that the protein component of the ruminant feed should be “protected” against being solubilized or metabolized in the rumen so that the protein component may pass through the rumen in substantially undegraded form, while remaining digestible and metabolizable in the post-rumen digestive system of ruminants such as cattle or sheep. After much research, a practical manner for applying this protein-protecting concept to ruminant nutrition was developed. However, although such protein-protected feeds (also termed high bypass protein feeds) are excellent sources of protein, they are generally quite low in fat content, and hence do not concurrently serve as a high-energy source.

With reference to feeding value lost by rumen destruction, soybean meal has a relatively low protein efficiency value. See Klopfenstein, Feedstuffs, July, 1981, 23-24. Since soybean meal is one of the major protein-containing feed materials used with cattle, it is particularly desirable to provide a commercially practical means for protecting soybean meal against rumen destruction while leaving the protein thereof subject to post-rumen digestion and metabolism. For large-scale commercial use such a method must be simple, efficient, and relatively inexpensive.

U.S. Pat. No. 5,824,355 discloses methods for manufacturing cooked protein protected ruminant feeds comprising the steps of mixing oil seed meal and hulls in a specified ratio to give a combined feed solids mixture; adding water to the combined feed solids mixture in a specified amount to give a moist meal feed; cooking the moist meal feed at a temperature of at least 200° F. for a time sufficient to reduce the water content to within a specified range and give a moist cooked meal; drying the moist cooked meal in a dryer under conditions sufficient to further reduce the water content to within a specified lower range and give a dried meal; and cooling the dried meal to give a protein protected ruminant feed. The protein protected ruminant feeds disclosed therein are less digestible in the rumen and thereby enhance ruminant growth and milk production. However, this patent makes no mention of protein-protected feeds that simultaneously supply high levels of energy along with high levels of post-rumen digestible protein.

### SUMMARY OF THE INVENTION

It is an object of this invention to provide a method for manufacturing ruminant feeds that are not easily destroyed in the rumen and which simultaneously contain high energy content and deliver a large amount of protein to the post-rumen digestive system of ruminants.

It is yet another object of this invention to provide a novel ruminant feed that, when consumed by lactating cows, increases their milk production.

It is still another object of this invention to provide a novel ruminant feed that accelerates the weight gain of animals that eat the feed.

It is a further object of this invention to provide a protein protected ruminant feed that contains no chemical additives.

In one embodiment, this invention is a process for manufacturing a high-energy protein-protected ruminant feed. The process comprises the steps of mixing oil seed meal with hulls to give a combined feed solids mixture having a hull/oil seed meal weight ratio of from about 1:100 to about 10:100. Water and fat are simultaneously or sequentially added to the combined feed solids mixture in amounts based on the oil seed meal weight in the combined feed solids mixture of from about 15 to about 50 percent by weight water and from about 1 to about 15 percent by weight fat to give a moist refatted meal feed. The moist refatted meal feed is then cooked in a cooker for a period of time sufficient to give a moist refatted cooked meal having a temperature of at least 200° F. and a moisture content based on the amount of oil seed meal in the combined feed solids mixture of from about 21 to about 26 percent by weight. The moist refatted cooked meal is then dried in a dryer at conditions of temperature and time sufficient to give a dried meal having a moisture content based upon the amount of oil seed meal used in the combined feed solids mixture of from about 12 to about 16 percent by weight. Finally, the dried meal is cooled in a cooler to give a protein protected ruminant feed having a temperature less than 25° F. above ambient temperature.

In another embodiment, this invention is a high energy protein protected ruminant feed comprising at least about 30 percent by weight crude protein (CP) and from about 1 to about 20 percent by weight fat on a dry matter basis. The high-energy protein-protected ruminant feed has unique properties, simultaneously providing a high-energy source of fat and a ruminantly undegradable protein (RUP) value greater than about 55 percent of CP.

In still another embodiment, this invention is a method for improving milk production from a lactating cow. The method comprises feeding the lactating cow a high energy protein protected ruminant feed comprising at least about 30 percent by weight crude protein (CP) and from about 1 to about 20 percent by weight fat on a dry matter basis.

### DESCRIPTION OF THE DRAWINGS

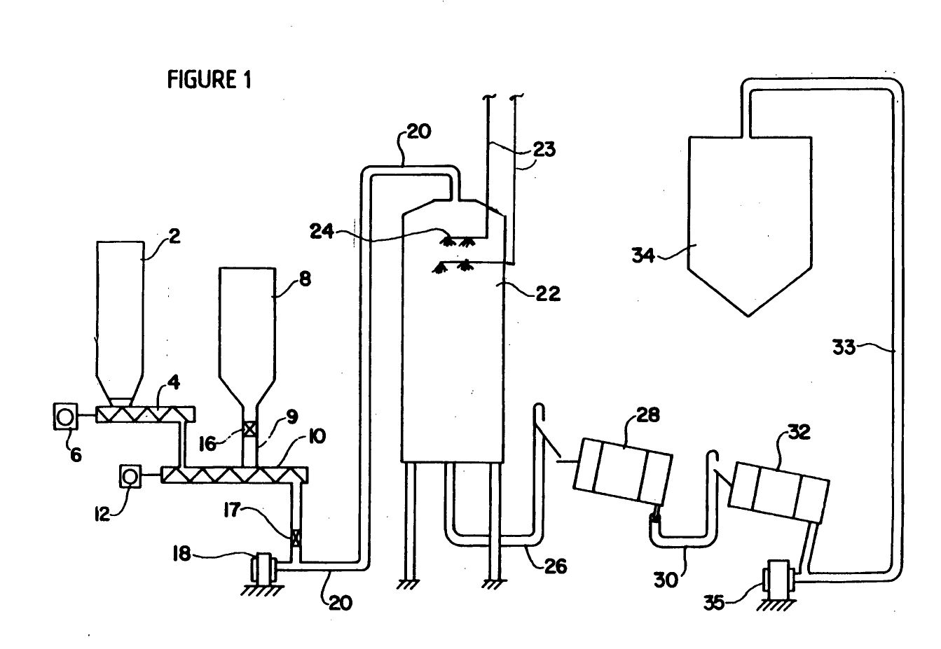

There is shown in FIG. 1 a presently preferred embodiment of a process for manufacturing a protein protected ruminant feed of this invention.

### DESCRIPTION OF A PREFERRED EMBODIMENT

The present invention relates to process for manufacturing a high energy protein protected ruminant feed as well as a novel high energy protein protected ruminant feed. The improved processes of the invention can be conducted as batch, semi-continuous, or continuous processes.

The processes of the invention require forming a moist refatted meal feed by combining oil seed meal, hulls, water, and fat in specified amounts, and then converting the moist refatted meal feed into a high energy protein protected ruminant feed. The oil seed meal may be any one or mixture of proteinaceous ruminant feed meals such a soybean meal, canola meal, sunflower meal, cottonseed meal, and so forth. It is preferred that the oil seed meal is soybean meal due to its high protein content and amino acid balance.

Hulls are combined with the oil seed meal to give a combined feed solids mixture. Suitable hulls include those derived from any one or mixture of the meal sources identified above, with soybean hulls being preferred. One purpose of adding hulls to the moist meal feed is to provide an additional natural source of sugars. An additional purpose of adding hulls is to obtain a proper fiber/protein feed balance. The oil seed meal is combined with the hulls at a hull/oil seed meal weight ratio ranging from about 1:100 to about 10:100. A preferred hull/oil seed meal weight ratio range is from about 3:100 to about 6:100.

Water and fat are simultaneously or sequentially added to the combined feed solids mixture in amounts based on the oil seed meal weight in the combined feed solids mixture of from about 15 to about 50 percent by weight water and from about 1 to about 15 percent by weight fat to give a moist refatted meal feed. The preferred moisture content of the moist refatted meal feed is from about 25 to about 40 percent based upon the weight of oil seed meal in the combined feed solids mixture.

The preparation of the moist refatted meal feed is preferably an automated process Automation assures that the appropriate ratio of hulls, fat, and water to oil seed meal are maintained at all times. The oil seed meal flow is preset to control the feed rate in pounds per minute or any other appropriate feed flow rate measure. The hull flow rate is set at a percentage of the oil seed meal feed rate. Typically, the oil seed meal and the hulls will be combined and mixed together in a solids mixer such as a paddle mixer, a tumbler, a ribbon mixer, a screw conveyor, a muller, or any other type of solid/solid mixer known in the art for a short period of time to thoroughly combine the solid ingredients. The combined solid ingredients are then conveyed to cooker where the combined feed solids mixture is sprayed or otherwise contacted with water and fat to achieve the desired moisture and fat levels in the resulting moist refatted meal feed.

To achieve the desired moisture level in the moist refatted meal feed, water may be added to the combined feed solids mixture in any manner known in the art. Water may be admixed with the combined feed solids in a mixer, water may be sprayed directly onto the combined feed solids, water may be injected into a screw conveyor conveying the combined feed solids, and so forth. It is referred that water is sprayed evenly on the combined feed solids just prior to cooking the moist refatted meal feed.

Before, during, or after the water addition, fat may be added in any manner known in the art to the combined feed solids mixture. As used herein, the term fat means any one or mixture of natural or synthetic glycerol esters in liquid or solid form. Liquid glycerol esters are sometimes termed oils, and solid glycerol esters are sometimes termed waxes; hence, the term fat as used herein encompasses both oils and waxes. The fat added to the combined feed solids may contain water or it may be substantially water-free.

Exemplary but non-limiting fats include any one or mixture of saturated and unsaturated glycerides, phosphoglycerides, and other lipids. One preferred glyceride is vegetable oil, especially soybean oil, obtained either by alkali refining, physical refining, or organic acid refining as disclosed in U.S. Pat. No. 6,172,248, hereby incorporated by reference herein. Another preferred glyceride source is condensed distillers soluble, obtained as a byproduct in corn-ethanol processing. A further preferred glyceride source is animal fats. A preferred phosphoglyceride is vegetable oil phospholipid, obtained either by conventional degumming of vegetable oil, especially soy bean oil, or as a valuable byproduct of organic acid refining, as disclosed in U.S. Pat. No. 6,172,248. Most preferably, the fat to be added to the combined feed solids is a vegetable oil, condensed distillers solubles, a vegetable oil phospholipid, or a mixture thereof.

The moist refatted meal feed is next cooked. The cooking may be accomplished in any cooker known in the art for cooking animal feeds. Examples of feed cookers useful for cooking the moist refatted meal feed include rotary steamed tube cookers, stacked cookers, fluid bed cookers, and scraped cookers. It is preferred that the moist refatted meal feed cooker is a stacked feed cooker having a plurality of heated decks, each heated deck including at least one sweep arm to agitate the moist meal feed to prevent overcooking and burning and to encourage evaporation of some water from the moist refatted meal feed during the cooking step.

The moist refatted meal feed is cooked in the cooker for a period of time sufficient to raise the temperature of the moist refatted meal feed to at least 200° F. and to lower the moist refatted meal feed moisture content to from about 21 to about 26 percent by weight based on the weight of oil seed meal in the mixture to give a moist cooked feed. This means that the cooker will generally operate at temperatures ranging from about 150 to about 220° F., or those temperatures designed to prevent overcooking and/or burning of the moist refatted meal feed in the cooker.

The moist refatted cooked feed exiting the cooker is conveyed to a dryer. The dryer may be any type of dryer known in the art to be capable of drying animal feeds. Examples of dryers useful in the process of this invention include tray dryers, vacuum shelf dryers, continuous tunnel dryers, and indirect and direct rotating dryers. A preferred dryer is a rotary dryer. The moist refatted cooked feed is conveyed to and dried in dryer at a temperature, and for a period of time sufficient to reduce moisture to a level of from about 12 to about 16 percent by weight, and preferably from about 13 to about 14 percent by weight, based on the weight of oil seed meal feed rate. Thus, the dryer temperature will range from about 100 to about 150° F. during the drying step, and the drying step will typically continue for from 10 minutes to about 2 hours or more. The rotational speed of the preferred rotating dryer can be varied to control the residence time of the moist refatted cooked feed in the rotary dryer and thereby control the moisture content of the resulting dried feed. The excess moisture in the moist refatted cooked feed that is removed in the dryer is typically vented to the atmosphere.

The dried feed leaving the dryer is then conveyed to a feed cooler where the still hot dried feed is cooled to close to ambient temperature. Any device known in the art for mixing and cooling animal feeds may be used to cool the dried feed. An especially useful cooler is a rotary cooler. The still hot, dried feed is cooled in the rotary cooler until the dried feed reaches a temperature of no ore than 25° F. above ambient temperature, and preferably no more than 15° F. above ambient temperature. During the cooling step, the moisture content of the dried feed will drop an additional 0.5 to about 2 percent by weight compared to the moisture level of the dried feed exiting the drier.

The cooled high energy protein protected ruminant feed product is then conveyed to a product bin where it can be shipped via truck, train, or any other means for sale and use.

The following Table I details important parameters of the protein protected ruminant feed production processes of this invention.

TABLE I

| | |
|---|---|
| Feed Components | |
| High Protein Meal | 100 parts |
| Hulls | from about 1 to about 10 parts |
| Water | from about 15 to about 50% of HiPro Meal |
| | amount |
| Fat | from about 1 to about 15% of HiPro Meal amount |
| Cooker Parameters | |
| Inlet Temp. | 150° F. min. |
| Outlet Temp. | 200° F. min. |
| Outlet Feed Moisture | from about 21 to about 26 percent by weight |
| Dryer Parameter | |
| Temperature | from about 100 to about 150° F. |
| Drying Time | at least about 10 minutes |
| Outlet Feed Moisture | from about 12 to about 16 percent by weight |
| Cooler Parameter | |
| Discharge Moisture | from about 10 to about 14.5 percent by weight |
| Color | Chocolate Brown |
| Smell | Sweet/Molasses |
| Appearance | Uniform - No Black Specs |

A preferred process for manufacturing high-energy protein-protected ruminant feeds is shown in FIG. 1. High protein oil meal feed is fed from oil meal feed hopper 2 into first conveyor 4. First conveyor 4 may be any type of conveyor capable of conveying solids such as a screw feeder or a conveyor belt. First conveyor 4 is driven by first feed conveyor driver 6 and the high protein feed is directed by first conveyor 4 into a second feed conveyor 10. A hull hopper 8 is associated with second feed conveyor 10 by conduit 9. A first airlock 16 in conduit 9 is used to control the rate of addition of hulls to the oil seed meal. Second feed conveyor 10 may be any type of conveyor useful for conveying solids such a screw drives and conveyor belts. It is preferred that second feed conveyor 10 is a screw conveyor that is capable of mixing the hulls and the oil seed meal that is conveyed by second feed conveyor 10. A second feed conveyor driver 12 is used to drive second feed conveyor 10.

The oil seed meal/hull mixture, combined and mixed by second feed conveyor 10, is directed to cooker 22 by directing a controlled amount of the mixture into second airlock 17. Second airlock 17 is then actuated and the controlled amount of feed mixture is directed into a pneumatic conduit 20 where first blower 18 forces the mixture through pneumatic conduit 20 and into feed cooker 22. Water and fat from one or a plurality of headers 23 is directed into feed cooker 22 at a controlled rate and sprayed evenly over the oil seed meal/hull mixture with one or a plurality of sprayers 24 to give a moist refatted feed mixture having a moisture content of from about 15 to about 50 percent by weight and a fat content of from about 1 to about 15 percent by weight, based on the oil seed meal weight in the combined feed solids mixture.

Feed cooker 22 is operated with a minimum inlet temperature of 150° F. The moist refatted feed mixture is kept in feed cooker 22 to give a moist cooked feed. The moist cooked feed exiting feed cooker 22 will have a minimum temperature of 200° F. and a moisture content of from about 21 to about 26 percent by weight, and preferably from about 23 to about 25 percent by weight.

Moist refatted cooked feed exits cooker 22 where it is conveyed to dryer 28 by a first drag conveyor 26. Dryer 28 is preferable a rotary drier that is operated at a temperature ranging from about 100 to about 150° F. The moist refatted cooked feed is dried in dryer 28 for a period of time ranging from about 10 minutes to about 2 hours or more until the moisture content of the dried feed ranges from about 12 to about 16 percent by weight based upon the oil meal feed content of the oil feed meal/hull mixture. Thereafter, the dried cooked feed is directed to a dried feed cooler 32 by second drag conveyor 30.

Dried feed cooler 32 is preferably a rotary cooler and the dried feed is cooled in dried feed cooler 32 until the temperature of the dried feed drops to at least below 25° F. above the ambient temperature and preferably below at least 15° F. above the ambient temperature. While in dried feed cooler 32, additional moisture evaporates from the dried feed so that the resulting high-energy protein-protected ruminant feed exiting dried feed cooler 32 has a moisture content of from about 10-13 percent by weight and preferably a moisture content of from about 12 to about 12.5 percent by weight based on the oil meal feed content of the oil meal feed/hull mixture.

The cooled high-energy protein-protected ruminant feed is directed to product hopper 34 via pneumatic conduit 33 associated with second blower 35, whereupon the high-energy protein-protected ruminant feed is stored for shipping and/or use. The resulting high-energy protein-protected ruminant feed produced by the process of this invention will comprise at least about 30 percent by weight crude protein (CP) and from about 1 to about 20 percent by weight fat on a dry matter basis, and will have a ruminantly undegradable protein (RUP) value greater than about 55 percent of CP.

### EXAMPLES

In the following examples, the values for RUP (ruminantly undegraded protein) were calculated and presented as follows:

%RUP=100-[(% of original protein which is available−% of original protein digested in the rumen)/% of original protein available]

The amount of original feed protein digested in the rumen was measured after incubation in the rumen of dairy cows for 16 hours, as described in detail below.

The extent to which bypass protein is digestible in the lower gut after escaping destruction in the rumen is important for nourishment of the animal. Digestibility of bypass protein is measured by ADI-CP (acid detergent insoluble-crude protein). The lower the ADI-CP value, the more digestible the bypass protein is. A useful evaluation method for measuring the amount of bypass protein is the in situ Dacron® bag test, described as follows.

From about 1 to about 2 grams of test product is placed into Dacron® bags measuring 5 cm by 10 cm and having a pore size of from about 50 to about 55 microns (such bags available commercially from Ankom, 140 Turk Hill Park, Fairport, N.Y. 14450) and the bags are then heat-sealed approximately 10 mm from the top of the bag. One or more sealed Dacron® bags are then placed for incubation within a nylon mesh lingerie bag equipped with a nylon zipper. The maximum number of bags that should be incubated in a single nylon mesh bag is 50. Each lingerie bag is weighted with stainless steel weights to ensure positioning in the ventral sac of the rumen. Incubation occurs for 16 hours to provide a relative estimate of the extent of ruminal fermentation in vivo.

A minimum of two animals (in most cases, the test animals are lactating cows) are used for each test run, and each test sample is incubated in triplicate within each animal. Animals are fed a diet comprising forages and feed concentrates for at least seven days before the bags are incubated. Feed is offered for ad libitum or 90% of ad libitum consumption.

Bags are recovered after incubation and rinsed in two stages. First, the bags are removed from the rumen and washed in buckets of tap water until the rinse water is clear. Alternatively, an automatic bag washer may be used if one is available, running water through the bag washer until the water runs clear. The rinsing second stage is a hand wash of each bag individually to remove any remaining residue. Washed bags are then dried to constant weight in a 55° C. oven, generally over a period of 24 to 48 hours. Bags are then allowed to air equilibrate and are weighed. A separate bag is run to determine the relative moisture of the bag set. Original and rumen-incubated test samples are then analyzed for dry matter and protein, and RUP is calculated according to the equation above.

The effects of the high-energy protein-protected ruminant feed of this invention on the RUP and of feeds, the digestibility of bypass protein in the lower gut, and the use of protein-protected feeds in feeding ruminants, are illustrated by the following examples.

### Example 1

Various formulations were prepared as summarized in Table II. A single lot of soybean meal (SBM; defatted and toasted) was used. A portion of the lot was retained as a control. The remainder was treated by adding approximately 6 percent by weight hulls to the soybean meal, based upon the weight of the soybean meal, and mixing the soybean meal and hulls in a paddle mixer for about one minute to give mixed feed solids. The mixed feed solids were then placed in a pan whereupon the mixed feed solids were mixed with the indicated amounts of water and vegetable oil phospholipids (VOP) to give a moist refatted meal feed.

The various moist refatted meal feeds were cooked for 4 hours at 105° C. The pans were uncovered during this heating step. The resultant hot dried cooked product was then cooled.

Samples of the control and test products were evaluated for potential rumen bypass properties by the in situ dacron bag method used to measure RUP as described earlier. Samples were also assayed for protein, acid detergent insoluble-crude protein (ADI-CP), fat and fiber. Results are shown in Table III.

TABLE II
Composition

| | A | B | C | D |
|---|---|---|---|---|
| HiPro Soybean Meal | 235 gm | 188 gm | 188 gm | 188 gm |
| (SBM - 10% native | | | | |
| water) | | | | |
| Untoasted soybean | 15 gm | 12 gm | 12 gm | 12 gm |
| hulls | | | | |
| Water | — | 50 ml | 37.5 ml | 25 ml |
| Vegetable Oil | — | — | 25 ml | 50 ml |
| Phospholipids (50:50 | | | | |
| fat:water) | | | | |
| Heated 4 hours at | No | Yes | Yes | Yes |
| 105° C. | | | | |

TABLE III
Analyzed Properties

| | | | Crude | | | Crude |
|---|---|---|---|---|---|---|
| Test | Dry Matter | RUP | Protein | ADI-CP | | Fiber |
| Product | Bypass (%) | (% of CP) | (%) | (%) | Fat (%) | (%) |
| A | 35.1 | 45.4 | 51.5 | 0.3 | 1.8 | 4.8 |
| B | 53.8 | 79.5 | 50.9 | 0.9 | 2.0 | 4.7 |
| C | 52.3 | 75.6 | 48.8 | 0.5 | 6.8 | 4.8 |
| D | 54.2 | 79.2 | 47.0 | 1.1 | 10.7 | 4.2 |

The results summarized for Test Product B in Table III show that cooking a mixture of soybean meal, hulls, and water produced a large increase in the bypass protein level (RUP) compared to Control Product A without changing intestinal digestibility (as shown by the low level of ADI-CP following heating). Adding 25 and 50 ml (10 and 20 percent by weight) VOP in Test Products C and D, respectively, to the mixture of soybean meal, hulls, and water prior to heating also produced a large increase in bypass protein level compared to Control Product A, similar to the increase observed in Test Product B where no VOP was added. However, the 10 and 20 percent by eight VOP content of Test Products C and D successively increased fat level compared to Control Product A and Test Product B, thereby producing a large increase in the energy level of the product. At the same time, adding VOP to the mixture prior to heating did not affect the intestinal digestibility of the protein, as shown by the low ADI-CP levels observed for Test Products C and D.

### Example 2

Various formulations as summarized in Table IV were prepared in the manner described in Example 1, except that during the first three hours of the heating step, the pans containing the moist refatted meal feeds were covered with foil to retain moisture. During the last hour of heating, the pans were uncovered to promote drying. Samples of the control and test products were evaluated for potential rumen bypass properties by the in situ dacron bag method used to measure RUP as described earlier. Samples were also assayed for protein, ADI-CP, fat and fiber. Results are shown in Table V.

TABLE IV
Composition

| | E | F | G | H | I |
|---|---|---|---|---|---|
| HiPro Soybean Meal | 235 gm | 188 gm | 188 gm | 188 gm | 188 gm |
| (SBM - 10% native | | | | | |
| water) | | | | | |
| Untoasted soybean | 15 gm | 12 gm | 12 gm | 12 gm | 12 gm |
| hulls | | | | | |
| Water | — | 50 ml | 41.2 ml | 23.8 ml | 6.2 ml |
| Vegetable Oil | — | — | 17.5 ml | 17.5 ml | 17.5 ml |
| Phospholipids (50:50 | | | | | |
| fat:water) | | | | | |
| Condensed Distillers | — | — | — | 25 ml | 50 ml |
| Solubles (30:70 | | | | | |
| fat:water) | | | | | |
| Heated 4 hours at | No | Yes | Yes | Yes | Yes |
| 105° C. | | | | | |

TABLE V
Analyzed Properties

| | | | Crude | | | Crude |
|---|---|---|---|---|---|---|
| Test | Dry Matter | RUP | Protein | ADI-CP | | Fiber |
| Product | Bypass (%) | (% of CP) | (%) | (%) | Fat (%) | (%) |
| E | 24.02 | 31.65 | 52.6 | 1.2 | 1.7 | 4.8 |
| F | 41.76 | 59.26 | 51.5 | 1.0 | 1.7 | 5.1 |
| G | 46.76 | 67.58 | 48.8 | 0.9 | 7.1 | 5.2 |
| H | 46.20 | 65.48 | 49.0 | 1.2 | 6.1 | 4.7 |
| I | 47.26 | 68.97 | 48.3 | 0.8 | 6.6 | 4.6 |

The results summarized for Test Product F in Table V again show that cooking a mixture of soybean meal, hulls, and water produced a large increase in the bypass protein level (RUP) compared to Control Product E without changing intestinal digestibility (as shown by the low level of ADI-CP following heating). Adding 17.5 ml (7 percent by weight) VOP in Test Product G to the mixture of soybean meal, hulls, and water prior to heating also produced a large increase in bypass protein level compared to Control Product E, and actually increased RUP relative to the already-increased value obtained in Test Product F, which did not contain VOP. Adding 25 and 50 ml (10 and 20 percent by weight) condensed distillers solubles in Test Products H and I, respectively, to the mixture of soybean meal, hulls, water, and VOP prior to heating also produced a large increase in bypass protein level compared to Control Product E, and produced RUP values similar to those obtained for Test Product G. These results again show that adding VOP to a mixture of soybean meal, hulls, and water prior to heating produces a large increase in bypass protein level and an increase in fat level while at the same time does not affect intestinal digestability. These results also show that the neither the increased bypass effect nor the intestinal digestability were diminished when a mixture of VOP and condensed distillers solubles was used as the fat fraction.

### Example 3

Various formulations as summarized in table VI were prepared in the manner described in example 2. Samples of the control and test products were evaluated for potential rumen bypass properties by the “in situ” Dacron bag method used to measure RUP as described earlier. Samples were also assayed for protein, ADI-CP, fat and fiber. The results are shown in table VII.

TABLE VI
Composition

| | J | K | L | M |
|---|---|---|---|---|
| HiPro Soybean Meal | 235 gm | 188 gm | 188 gm | 188 gm |
| (SBM - 10% native water) | | | | |
| Untoasted soybean hulls | 15 gm | 12 gm | 12 gm | 12 gm |
| Water | — | 50 ml | 46.9 ml | 43.8 ml |
| Vegetable Oil | — | — | 6.25 ml | 12.5 ml |
| Phospholipids (50:50 fat:water) | | | | |
| Heated 4 hours at 105° C. | No | Yes | Yes | Yes |

TABLE VII
Analyzed Properties

| | | | Crude | | | Crude |
|---|---|---|---|---|---|---|
| Test | Dry Matter | RUP | Protein | ADI-CP | | Fiber |
| Product | Bypass (%) | (% of CP) | (%) | (%) | Fat (%) | (%) |
| J | 37.0 | 51.3 | 51.4 | 4.8 | 2.0 | 5.1 |
| K | 52.4 | 73.5 | 51.1 | 1.0 | 1.6 | 4.8 |
| L | 56.6 | 78.7 | 50.6 | 0.5 | 3.5 | 4.9 |
| M | 54.4 | 75.0 | 50.8 | 0.7 | 4.3 | 4.6 |

The results summarized for test product K in table VII again show that cooking a mixture of soybean meal, hulls and water produced a large increase in the bypass protein level (RUP) compared to the control product J without decreasing intestinal digestibility (as shown by the lower level of ADI-CP following heating). Adding 6.25 ml (2.5 percent by weight) or 12.5 ml (5 percent by weight) VOP in test products L and M, respectively to the mixture of soybean meal, hulls and water prior to heating also produced a large increase in bypass protein level compared to control product J, similar to the increase observed with test product K where no VOP was added. However, the 2.5 and 5 percent by weight VOP content of test products L and M successively increase fat level compared to control product J and test product K, thereby producing a large increase in the energy level of the product. At the same time, adding VOP to the mixture prior to heating did not decrease the intestinal digestibility of the protein as shown by the low ADI-CP levels observed for test products L and M.

The invention and the manner and process of making and using it, are now described in such full, clear, concise and exact terms as to enable any person skilled in the art to which it pertains, to make and use the same. Although the foregoing describes preferred embodiments of the present invention, such description has been offered for illustrative purposes only and is not intended to limit the scope of the invention. Modifications may be made without departing from the spirit or scope of the present invention as set forth in the claims. To particularly point out and distinctly claim the subject matter regarded as invention, the following claims conclude this specification.

What I claim is:

1. A process for manufacturing a high energy protein protected ruminant feed, comprising:
(a) mixing oil seed meal with hulls to give a combined feed solids mixture having a hull/oil seed meal weight ratio of from about 1:100 to about 10:100;
(b) simultaneously or sequentially adding water and fat to the combined feed solids mixture in amounts based on the weight of oil seed meal in the combined feed solids mixture of from about 15 to about 50 percent by weight water and from about 1 to about 15 percent by weight fat to give a moist refatted meal feed;
(c) cooking the moist refatted meal feed in a cooker for a period of time sufficient to give a moist refatted cooked meal having a temperature of at least 200° F. and a moisture content based on the weight of oil seed meal in the combined feed solids mixture of from about 21 to about 26 percent by weight;
(d) drying the moist refatted cooked meal in a dryer at conditions of temperature and time sufficient to give a dried meal having a moisture content based upon the weight of oil seed meal used in the combined feed solids mixture of from about 12 to about 16 percent by weight; and
(e) cooling the dried meal in a cooler to give a high energy protein protected ruminant feed having a temperature less than 25° F. above ambient temperature.

2. The process of claim 1, wherein the cooker is a stacked cooker.

3. The process of claim 1, wherein the dryer is a rotary dryer.

4. The process of claim 1, wherein the cooler is a rotary drum cooler.

5. The process of claim 1, wherein the oil seed meal is soybean meal.

6. The process of claim 1, wherein the hulls are soybean hulls.

7. The process of claim 6, wherein the soybean hull/soybean meal weight ratio in the combined solids feed mixture is from about 3:100 to about 6:100.

8. The process of claim 1, wherein the moisture content of the moist meal feed is from about 25 to about 40 percent by weight of the oil seed meal weight in the combined feed solids mixture.

9. The process of claim 1, wherein the fat is selected from the group consisting of vegetable oil, vegetable oil phospholipids, condensed distillers solubles, animal fat, or mixtures hereof.

10. The process of claim 9, wherein the fat is soybean oil phospholipids.

11. A process for manufacturing a cooked protein protected ruminant feed comprising the steps;
(a) mixing soybean meal with soybean hulls to give a combined feed solids mixture having a soybean hull/soybean meal weight ratio of from about 3:100 to about 6:100;
(b) simultaneously or sequentially adding water and fat to the combined feed solids mixture in amounts based on the weight of oil seed meal in the combined feed solids mixture of from about 25 to about 40 percent by weight water and from about 1 to about 15 percent by weight fat to give a moist refatted meal feed;
(c) cooking the moist refatted meal feed in a stacked cooker for a period of time sufficient to give a moist refatted cooked meal having a temperature of at least 200° F. and a moisture content based on the weight of soybean meal in the combined feed solids mixture of from about 21 to about 26 percent by weight;
(d) drying the moist refatted cooked meal in a rotating drum dryer at from about 100 to about 150° F. for a period of time sufficient to give a dried meal having a moisture content based upon the weight of soybean meal used in the combined feed solids mixture of from about 12 to about 16 percent by weight; and
(e) cooling the dried meal in a cooler to give a high energy protein protected ruminant feed having a temperature less than 15° F. above ambient temperature and having a moisture content of from about 10 to about 14.5 percent by weight based on the weight of soybean meal in the combined feed solids mixture.
